(19) United States
(12) Patent Application Publication
(10) Pub. No.: US 2020/0153593 A1
(43) Pub. Date: May 14, 2020

(54) REDUCING LATENCY ON LONG DISTANCE POINT-TO-POINT LINKS

(71) Applicant: QUALCOMM Incorporated, San Diego, CA (US)

(72) Inventors: Yiftach Benjamini, Givat Ela (IL); Shaul Yohai Yifrach, Haifa (IL); Lior Amarilio, Yokneam (IL)

(21) Appl. No.: 16/186,961

(22) Filed: Nov. 12, 2018

(51) Int. Cl. H04L 5/00; G06F 13/42; H04L 29/08; H04L 12/823; H04L 12/861

(52) U.S. Cl. CPC H04L 5/0055; G06F 13/4221; G06F 2213/0026; H04L 47/323; H04L 49/90; H04L 69/326

(57) ABSTRACT

Systems and methods for reducing latency on long distance point-to-point links where the point-to-point link is a Peripheral Component Interconnect (PCI) express (PCIE) link that modifies a receiver to advertise infinite or unlimited credits. A transmitter sends packets to the receiver. If the receiver's buffers fill, the receiver, contrary to PCIE doctrine, drops the packet and returns a negative acknowledgement (NAK) packet to the transmitter. The transmitter, on receipt of the NAK packet, resends packets beginning with the one for which the NAK packet was sent. By the time these resent packets arrive, the receiver will have had time to manage the packets in the buffers and be ready to receive the resent packets.

### BACKGROUND

### I. Field of the Disclosure

The technology of the disclosure relates generally to Peripheral Component Interconnect (PCI) express (PCIE) links and, more particularly, to long distance PCIE links.

### II. Background

Computing devices have evolved from their early forms that were large and had limited use into compact, multifunction, multimedia devices. The increase in functionality has come, in part, as a function of using integrated circuits (ICs) in place of the original vacuum tubes. Many computing devices include multiple ICs having different dedicated functions.

Various internal buses may be used to exchange data between the ICs, such as Inter-integrated circuit (I2C), serial AT attachment (SATA), serial peripheral interface (SPI), or other serial interfaces. One popular bus is based on the Peripheral Component Interconnect (PCI) express (PCIE) standard published by the PCI Special Interest Group (PCI-SIG), PCIE is a high-speed point-to-point serial bus. PCIE version 4 was officially announced on Jun. 8, 2017 and version 5 has been preliminary proposed at least as early as June 2017 with expected release in 2019.

PCIE is an ordered and reliable link. To help effectuate this order and reliability, PCIE uses, amongst other tools, a credit system, that tells a transmitter how much data a receiver can manage. The transmitter uses a credit with each packet of data sent to the receiver, and then, if the transmitter exhausts the available credits, the transmitter waits for the receiver to return a credit for a managed packet. PCIE initially started as a short distance chip-to-chip or chip-to-card communication link, with typical distances under ten centimeters (10 cm) and usually under 1 cm. These short distances meant that credits from the receiver were rapidly returned. However, the simplicity of PCIE has led to its adoption in environments that have substantially longer distances. For example, in an automotive setting, distances on the order of ten meters (10 m) may not be unusual. In such instances, the transmitter may use all of the credits before the first packet even arrives at the receiver. The transmitter then waits for the packet to arrive and the receiver to return the credit. One way to decrease this latency is to advertise more credits at the receiver. However, because PCIE is reliable, for the receiver to advertise more credits, the receiver must have sufficient buffer space to handle packets corresponding to each of those credits. Similarly, the transmitter must have sufficient replay buffers to store each packet until a credit or acknowledgment is returned. These buffers use relatively large amounts of space in the silicon of the devices and thus increase the cost of the devices. As link distances increase, the amount of buffers required to utilize full link bandwidth increases, adding to the size and cost of the device. Thus, there needs to be a way to reduce the size and cost of the devices coupled to long PCIE links while keeping latency to a minimum.

### SUMMARY OF THE DISCLOSURE

Aspects disclosed in the detailed description include systems and methods for reducing latency on long distance point-to-point links. In an exemplary aspect, the point-to-point link is a Peripheral Component Interconnect (PCI) express (PCIE) link. A receiver on the PCIE link advertises infinite or unlimited credits. A transmitter sends packets to the receiver. If the receiver's buffers fill, the receiver, contrary to PCIE doctrine, drops the packet and returns a negative acknowledgement (NAK) packet to the transmitter. The transmitter, on receipt of the NAK packet, resends packets beginning with the one for which the NAK packet was sent. By the time these resent packets arrive, the receiver will have had time to manage the packets in the buffers and be ready to receive the resent packets. This process results in an overall reduction of latency relative to the normal Kw approach without requiting additional butters.

In this regard in one aspect, a method of communicating over a point-to-point communication link is disclosed. The method includes, at a receiver, receiving packets from a transmitter until a buffer is full. The method also includes, responsive to the buffer being full, sending a NAK packet to the transmitter. The method also includes receiving retransmitted packets after sending the NAK packet to the transmitter.

In another aspect, an apparatus is disclosed. The apparatus includes a receiver. The receiver includes a communication link interface configured to be coupled to a communication link. The receiver also includes a butler configured to store packets received through the communication link interface. The receiver also includes a control system. The control system, responsive to the buffer being filled with packets, is configured to send a NAK packet to a transmitter through the communication link interface.

### BRIEF DESCRIPTION OF THE FIGURES

FIG. 1 is a block diagram of an exemplary computing system with devices coupled by Peripheral Component Interconnect (PCI) express (PCIE) buses;

FIG. 2 illustrates a block diagram of an exemplary PCIE endpoint device and, particularly, buffers within the endpoint;

FIG. 3 is a flowchart illustrating an exemplary process for managing packets to reduce latency in a point-to-point link;

FIG. 4A illustrates a conventional signal flow on a long distance point-to-point link showing credit-induced latency;

FIG. 4B illustrates a signal flow on a long distance point-to-point link showing improved flow control according to exemplary aspects of the present disclosure;

FIG. 4C illustrates a signal flow on a long distance point-to-point link where a full buffer at a receiver causes packets to be resent; and

FIG. 5 is a block diagram of an exemplary processor-based mobile terminal that can include the point-to-point links of FIG. 1 and use the process of FIG. 3.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include systems and methods for reducing latency on long distance point-to-point links. In an exemplary aspect, the point to point link is a Peripheral Component interconnect (PCI) express (PCIE) link. A receiver on the PCIE link advertises infinite or unlimited credits. A transmitter sends packets to the receiver. If the receiver's buffers fill, the receiver, contrary to PCIE doctrine, drops the packet and returns a negative acknowledgement (NAK) packet to the transmitter. The transmitter, on receipt of the NAK packet, resends packets beginning with the one for which the NAK packet was sent. By the time these resent packets arrive, the receiver will have had time to manage the packets in the buffers and be ready to receive the resent packets. This process results in an overall reduction of latency relative to the normal PCIE approach without requiring additional buffers.

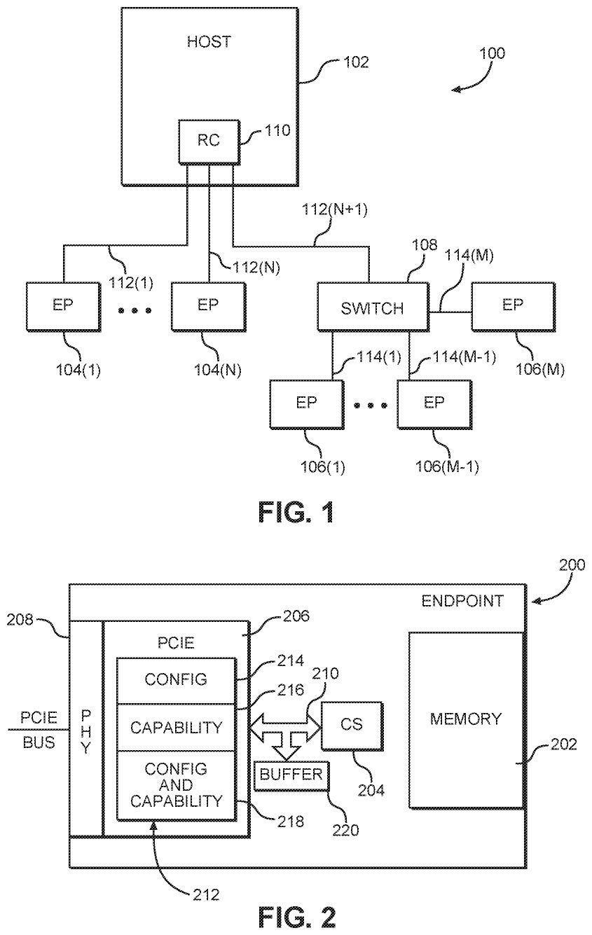

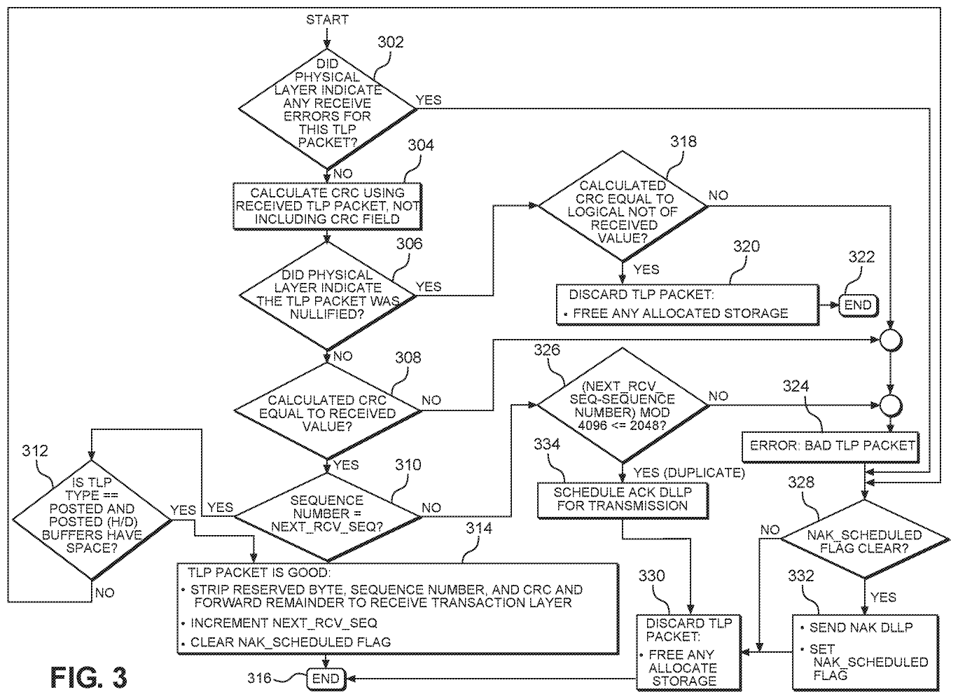

A brief overview of a computing system with PCIE links is provided with reference to FIG. 1 and FIG. 2 provides additional detail about a receiver within the computing system. A discussion of processes associated with the present disclosure begins below with reference to FIG. 3.

In this regard, FIG. 1 illustrates a computing environment 100 with a host 102 coupled to a plurality of devices 104(1)-104(N) directly and to a second plurality of devices 106(1)-106(M) through a switch 108. The host 102 may include a PCIE root complex (RC) 110 that includes a bus interface (not illustrated directly) that is configured to couple to plural PCIE buses 112(1)112(N+1). Note that while the communication links between the RC 110 and the devices 106(1)-106(M) are referred to as a bus, these links are point-to-point communication links, and the bus interface may also be referred to as a communication link interface. The switch 108 communicates to the de vices 106(1)-106(M) through PCIE buses 114(1)-114(M). The devices 104(1)-104(N) and 106(1)-106(M) may be or may include PCIE endpoints. In a first exemplary aspect, the computing environment 100 may be a single computing device such as a computer with the host 102 being a central processing unit (CPU) and the devices 104(1)-104(N) and 106(1)-106(M) being internal components such as hard drives, disk drives, or the like. In a second exemplary aspect, the computing environment 100 may be a computing device where the host 102 is an integrated circuit (IC) on a board and the devices 104(1)-104(N) and 106(1)-106(M) are other ICs within the computing device. In a third exemplary aspect, the computing environment 100 may be a computing device having an internal host 102 coupled to external devices 104(1)-104N and 106(1)-106(M) such as a server coupled to one or more external memory drives. Note that these aspects are not necessarily mutually exclusive in that different ones of the devices may be ICs, internal, or external relative to a single host 102.

FIG. 2 provides a block diagram of a device 20( )that may be one of the host 102, the devices 104(1)-104(N), or the devices 106(1)-106(M) of FIG. 1. In particular, the device 200 may act as a host or an endpoint in a PCIE system, and may be, for example, a memory device that includes a memory element 202 and a control system 204. Further, the device 200 includes a PCIE hardware element 206 that includes a bus interface configured to couple to a PCIE bus. The PCIE hardware element 206 may include a physical layer (PHY) 208 that is, or works with, the bus interface to communicate over the PCIE bus. The control system 204 communicates with the PCIE hardware element 206 through a system bus 210. The PCIE hardware element 206 may further include a plurality of registers 212. The registers 212 may be conceptually separated into configuration registers 214 and capability registers 216. The configuration registers 214 and the capability registers 216 are defined by the original PCI standard, and more recent devices that include the registers 214 and 216 are backward compatible with legacy devices. The configuration registers 214 include sixteen (16) double words (DWs). The capability registers 216 include forty-eight (48) DWs. The PCIE standard further defines additional registers found in a PCIE extended configuration register space 218. These registers did not exist in the original PCI standard, and thus, PCI legacy devices generally do not address these extra registers. The extended configuration register space 218 may be another 960 DWs. The control system 204 may further interoperate with buffers 220. While illustrated outside the PCIE hardware element 206, it should be appreciated that the buffers 220 may be in the PCIE hardware element 206. Incoming packets are stored in the buffers while the control system 204 processes other packets. In a well-designed system the control system 204 processes packets at least as fast as they arrive and the buffers 220 remain relatively empty. Note that the buffers 220 or other buffers (not illustrated) may also be provided for transmissions across the PCIE bus. These additional transmission buffers are designed to be large enough to hold all packets that have been transmitted until released by an acknowledgement (ACK) packet from the receiver. In the configuration registers 214 there may be an indication as to how many receiver credits are available for the device 200. In an exemplary aspect, the present disclosure sets this value to “unlimited” or “infinite.” This register may be read during link training, and the transmitter (not shown) sending commands, data, and the like to the device 200 may operate normally. Normally in this case means that, subject to process 300 described below, the transmitter continues to send packets to the device 200 without waiting for return of credits. The device 200, and particularly the receiver within the PCIE, hardware element 206, may operate according to the process 300 presented below.

In this regard, the process 300 begins much as the process outlined in FIG. 3-19 of the PCIE specification begins, by determining if the physical layer indicates any receive errors for this transport layer protocol (TLP) packet (block 302). If the answer is no, then the control system calculates a cyclic redundancy check (CRC) using the received TLP packet not including any CRC field in the TLP packet (block 304). The control system then determines if the physical layer indicates the TLP packet was nullified (block 306). If the answer to block 306 is no, then the control system determines if the calculated CRC is equal to the received value (block 308). If the answer to block 308 is yes, the control system determines if the sequence number is equal to the next sequence number expected (i.e., NEXT_RCV_SEQ) (block 310). To this point, the process 300 is in accord with the PCIE specification. However, exemplary aspects of the present disclosure add a step if the answer to block 310 is yes. In particular, if the answer to block 310 is yes, the control system determines if the TLP packet is appropriate and whether the header and data (H/D) buffers have space to store a packet (block 312). If the buffers are not full and the TLP packet is good, the process 300 begins managing the TLP packet by stripping off the reserved byte, sequence number, and CRC, incrementing the next sequence number expected, and clearing any. NAK_SCHEDULED flag (block 314). Then the process ends (block 316) until the next TLP packet is received.

If, however, there is an issue with the TLP packet, the process 300 has various ways of handling, depending on the nature of the issue. Thus, if the answer to block 306 is yes, the physical layer indicates the TLP packet was nullified, then the control system determines if the CRC is equal to logical NOT of the received value (block 318). If the answer to block 318 is yes, then the TLP packet is discarded and any storage allocated is freed (block 320) before the process ends (block 322). Likewise, if the answer to block 318 is no, or the answer to block 308 is no, then the control system indicates an error: bad TLP packet (block 324).

If the answer to block 310 is no, the sequence number is not correct, then the control system checks whether the received sequence number is in a window (2k) of sequence numbers before the expected sequence number. This check is made using a modulo 4096 operand on the difference of the expected sequence number from the received sequence number compared to 2048 (2k) (block 326). If the answer to block 326 is no, then the control system concludes that the TLP packet is a bad TLP packet (block 324). If the received sequence number is in the window, the PCIE protocol assumes that this is a packet for which an ACK was previously sent but not received for some reason and for which the transmitter has sent a duplicate. This duplication causes the receiver to resend the ACK through an ACK transmission (block 334).

Once there is a determination of a bad TLP packet at block 324, or after block 312 is answered affirmatively (i.e., the buffers are full), the control system determines if the NAK_SCHEDULED flag is clear (block 328) to see if a NAK packet has already been sent. If the flag is set, meaning there is already a NAK packet pending, then the control system discards the TLP packet and frees any allocated storage (block 330), and the process ends (block 316). If, however, the flag is clear at block 328, then the control system sends a NAK data link layer packet (DLLP) and sets the NAK_SCHEDULED flag (block 332).

Additionally, if block 326 is answered affirmatively, there is a duplicate, the control system schedules an ACK DLLP for transmission (block 334) and then moves to block 330 previously described.

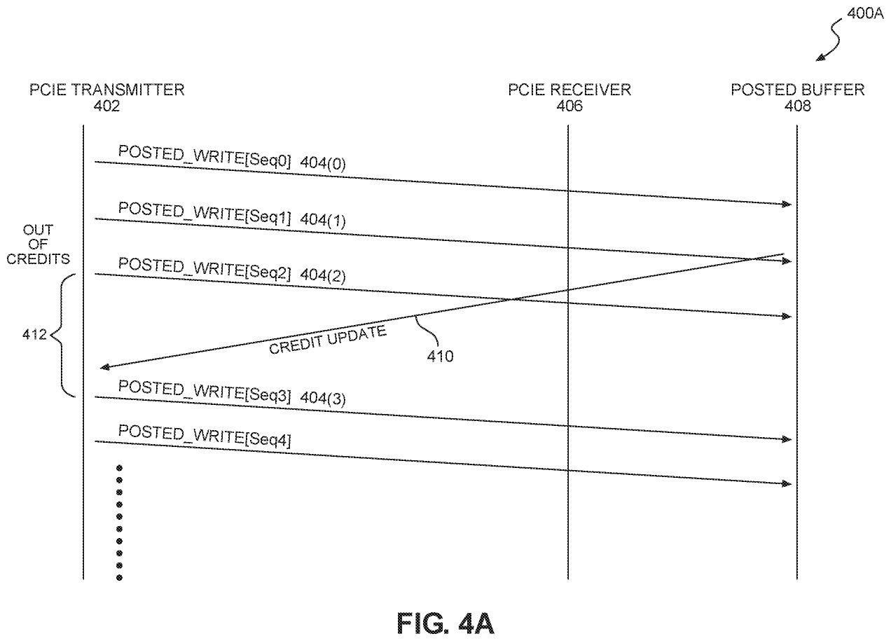

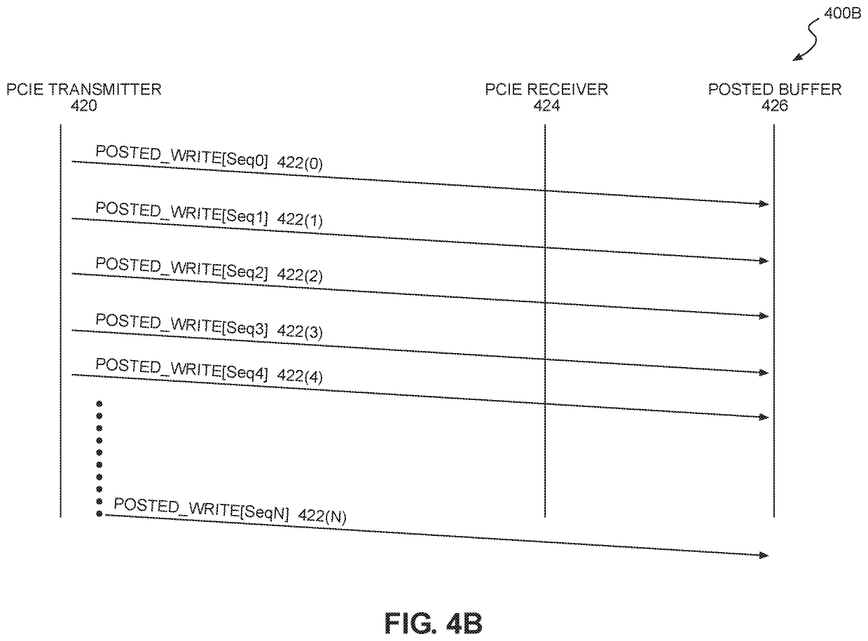

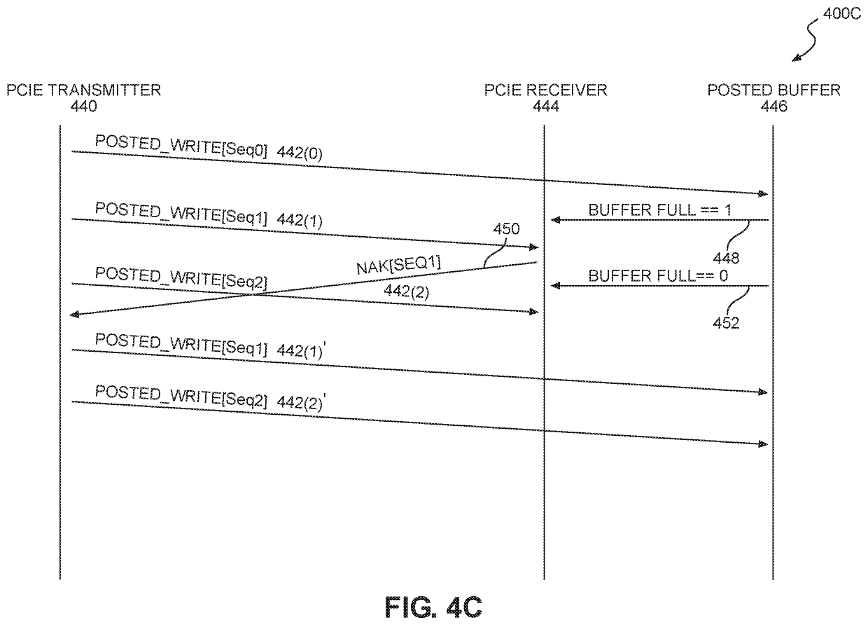

In the absence of the present disclosure, a transmitter may run out of credits even though the buffers of the receiver are not full. This situation is exacerbated on long PCIE links where the length of the link uses all of the credits before the first packet arrives at the receiver. This situation is illustrated in simplified form in FIG. 4A through signal flow 400A. A PCIE transmitter 402 sends packets 404(0)-404(2) with corresponding sequence numbers to a PCIE receiver 406. The packet 404(0) reaches a buffer 408 of the receiver 406, and the receiver 406 posts a credit update 410. However, the transmitter 402 runs out of credits after the packet 404(2) is sent, and then must wait for the credit update 410 to arrive before resuming sending packets with packet 404(3). The time 412 between running out of credits and arrival of the credit update 410 adds latency to the system.

Exemplary aspects of the present disclosure reduce this latency by allowing the receiver to publish infinite credits and drop packets when the buffers are full. When the receiver drops a packet, a NAK packet is sent indicating what sequence number was lost, and the transmitter resends the packet and all packets with higher sequence numbers that had been sent before arrival of the NAK packet. If the buffer size on the receiver matches the transfer rate, then no packets should be dropped. This situation is illustrated by signal flow 400B of FIG. 4B. A transmitter 420 sends packets 422(0)-422(N) to a receiver 424 without interruption, with each of the packets 422(0)-422(N) being handled by a buffer 426.

If for some reason, the buffers cannot handle the transfer rate, then the buffers will fill and begin to drop packets. At the point when the buffer is full, a NAK packet is sent to the transmitter to alert the transmitter to resend packets. While the use of a NAK packet to resend packets is known, it has never been used for intentionally dropped packets resulting from full buffers. However, because it is known to use NAK packets to resend packets, no change in the transmitter is required and backwards compatibility is maintained.

FIG. 4C illustrates a signal flow 400C where a NAK packet is sent according to an exemplary aspect of the present disclosure triggering reseeding of packets. In this regard, a transmitter 440 sends packets 442(0)-442(2) to a receiver 444. The receiver 444 puts the packet 442(0) into a buffer 446, which, in this example, fills the buffer 446. The buffer 446 returns a buffer full signal 448 and on receipt of the second packet 442(1), the receiver 444 returns a NAK packet 450 indicating that the second packet 442(1), identified by the sequence number, was not received. At some later point, the butler 446 returns a buffer not full signal 452. Meanwhile, the transmitter 440 has sent the third packet 442(2) because the transmitter 440 is, as of yet, unaware that the second packet 442(1) was dropped. On receipt of the NAK packet 450, the transmitter 440 resends the packets beginning with the packet that was dropped as well as any others that have been sent after the dropped packet. In this case, these are resent as packets 442(1)′ and 442(2)′.

The systems and methods for reducing latency on long distance point-to-point links according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a missile, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

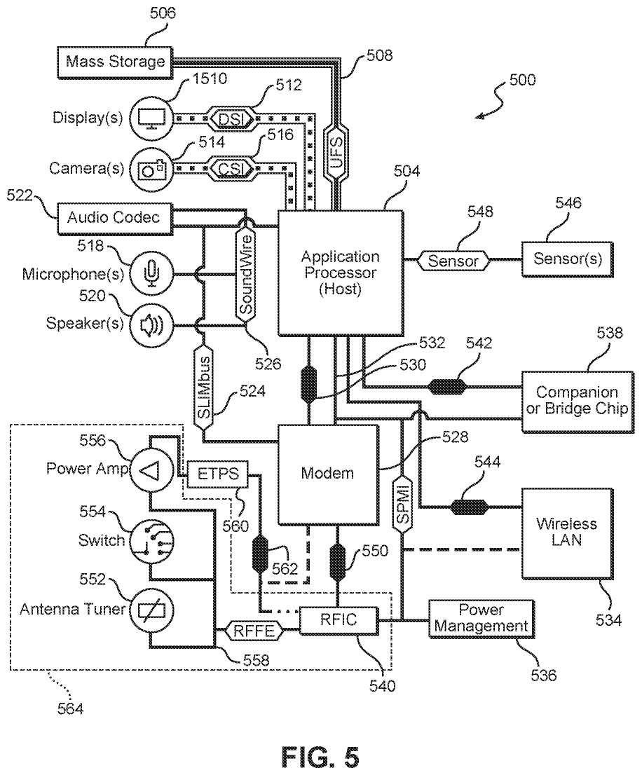

In this regard, FIG. 5 is a system-level block diagram of an exemplary mobile terminal 500 such as a smart phone, mobile computing device tablet, or the like. While a mobile terminal having a SOUNDWIRE bus is particularly contemplated as being capable of benefiting from exemplary aspects of the present disclosure, it should be appreciated that the present disclosure is not so limited and may be useful in any system having a time division multiplexed (TDM) bus.

With continued reference to FIG. 5, the mobile terminal 500 includes an application processor 504 (sometimes referred to as a host) that communicates with a mass storage element 506 through a universal flash storage (UFS) bus 508. The application processor 504 may further be connected to a display 510 through a display serial interface (DSI) bus 512 and a camera 514 through a camera serial interface (CSI) bus 516. Various audio elements such as a microphone 518, a speaker 520, and an audio codec 522 may be coupled to the application processor 504 through a serial low-power interchip multimedia bus (SLIMbus) 524. Additionally, the audio elements may communicate with each other through a SOUNDWIRE bus 526. A modem 528 may also be coupled to the SLIMbus 524 and/or the SOUNDWIRE bus 526. The modem 528 may further be connected to the application processor 504 through a PCI or PCIE bus 530 and/or a system power management interface (SPMI) bus 532.

With continued reference to FIG. 5, the SPMI bus 532 may also be coupled to a local area network (LAN or WLAN) IC (LAN IC or WLAN IC) 534, a power management integrated circuit (PMIC) 536, a companion IC (sometimes referred to as a bridge chip) 538, and a radio frequency IC (RFIC) 540. It should be appreciated that separate PCI buses 542 and 544 may also couple the application processor 504 to the companion IC 538 and the WLAN IC 534. The application processor 504 may further be connected to sensors 546 through a sensor bus 548. The modem 528 and the RFIC 540 may communicate using a bus 550.

With continued reference to FIG. 5, the RFIC 540 may couple to one or more RFFE elements, such as an antenna tuner 552, a switch 554, and a power amplifier 556 through a radio frequency front end (RFFE) bus 558. Additionally, the RFIC 540 may couple to an envelope tracking power supply (ETPS) 560 through a bus 562, and the ETPS 560 may communicate with the power amplifier 556. Collectively, the RFFE elements, including the RFIC 540, may be considered an RFFE system 564. It should be appreciated that the RFFE bus 558 may be formed from a clock line and a data line (not illustrated).

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration),

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combine& It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

1. A method of communicating over a point-to-point communication link, comprising:
at a receiver, receiving packets from a transmitter until a buffer is full;
dropping a packet when the buffer is full;
responsive to the buffer being full, sending a negative acknowledgment (NAK) packet to the transmitter; and
receiving retransmitted packets after sending the NAK packet to the transmitter.

2. The method of claim 1, wherein receiving the packets comprises receiving transport layer protocol (TLP) packets.

3. The method of claim 1, wherein receiving the packets from the transmitter comprises receiving packets over a Peripheral Component Interconnect (PCI) express (PCIE) link.

4. The method of claim 1, further comprising publishing at the receiver infinite credits to the transmitter.

5. The method of claim 1, further comprising storing received packets in the buffer for processing.

6. The method of claim 5, further comprising draining the buffer as the packets are processed.

7. The method of claim 1, wherein receiving the packets comprises receiving packets with a sequence number.

8. (canceled)

9. The method of claim 7, wherein sending the NAK packet comprises sending a NAK packet having a NAK sequence number associated with the dropped packet.

10. An apparatus comprising a receiver, the receiver comprising:
a communication link interface configured to be coupled to a communication link;
a buffer configured to store packets received through the communication link interface;
and
a control system configured to:
responsive to the buffer being filled with packets:
drop a packet when the buffer is full; and
send a negative acknowledgement (NAK) packet to a transmitter through the communication link interface.

11. The apparatus of claim 10, wherein the communication link interface comprises a Peripheral Component Interconnect (PCI) express (PCIE) interface.

12. The apparatus of claim 10, wherein the packets comprise transport layer protocol (TLP) packets.

13. The apparatus of claim 10, wherein the control system is further configured to publish infinite credits to the transmitter.

14. The apparatus of claim 10, wherein the control system is configured to process the packets stored in the buffer.

15. The apparatus of claim 14, wherein the control system is configured to drain the buffer as the packets are processed.

16. The apparatus of claim 10, wherein the packets comprise corresponding sequence numbers.

17. (canceled)

18. The apparatus of claim 16, wherein the NAK packet comprises a NAK sequence number associated with the dropped packet.

19. The apparatus of claim 10, comprising an integrated circuit (IC) comprising the receiver.

20. The apparatus of claim 10, further comprising a root complex and the communication link, the root complex also coupled to the communication link.

21. The apparatus of claim 20, wherein the root complex comprises the transmitter.

22. The apparatus of claim 21, wherein the root complex is configured to send packets unless the NAK packet is received.

23. The apparatus of claim 21, wherein the root complex is configured to receive an indication of infinite credits from the receiver.

24. The apparatus of claim 10, further comprising a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a missile, a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter incorporating the receiver, the communication link, and a host configured to transmit the packets.

25. The method of claim 1, further comprising:
before receiving the packets from the transmitter, publishing infinite credits to the transmitter; and
responsive to publishing the infinite credits, receiving the packets from the transmitter over a Peripheral Component Interconnect (PCI) express (PCIE) link greater than ten centimeters (10 cm) until the buffer is full.
